(19) United States
(12) Patent Application Publication
(10) Pub. No.: US 2025/0388491 A1
(43) Pub. Date: Dec. 25, 2025

(54) MECHANICAL WAVE GENERATOR TO AFFECT WATER QULAITY

(71) Applicants: Christopher S. Keever, Peachtree City, GA (US); Jared Holindrake, Cottonwood Heights, UT (US)

(72) Inventors: Christopher S. Keever, Peachtree City, GA (US); Jared Holindrake, Cottonwood Heights, UT (US)

(21) Appl. No.: 18/983,748

(22) Filed: Dec. 17, 2024

Related U.S. Application Data
(60) Provisional application No. 63/621,369, filed on Jan. 16, 2024.
(60) Provisional application No. 63/663,197, filed on Jun. 24, 2024.

(51) Int. Cl. C02F 1/34; C02F 3/16; C02F 7/00; C02F 103/00

(52) U.S. Cl. CPC C02F 1/34; C02F 3/16; C02F 7/00; C02F 2103/007; C02F 2201/002; C02F 2201/008; C02F 2201/009; C02F 2301/024

(57) ABSTRACT

Methods, systems, and apparatuses to create waves on the surface of a water body at select times, amplitude, frequency, water characteristics, or environmental conditions to affect sunlight penetration, heat and mass transfer, mixing, oxygenation, ice formation, weed suppression, harmful microbe suppression, insect suppression, and other factors.

### CROSS REFERENCE TO RELATED APPLICATION

This application claims priority to U.S. Provisional Application No. 63/663,197 filed Jun. 24, 2024 and U.S. Provisional Application No. 63/621,369 filed Jan. 16, 2024, both of which are incorporated herein by reference in their entirety.

### BACKGROUND OF THE INVENTION

Water quality in ponds and reservoirs is affected by many factors, including environmental, biological, chemical, and other factors. The proliferation of algae and imbalances in algal species can present specific water quality challenges relating to pH, dissolved oxygen, fish kills, taste and odor problems, and suspended solids (and others). Certain algae species and other microbes can produce toxins harmful to both aquatic life and human health, creating concerns for water quality and safety. Freezing temperatures present issues in agriculture, livestock, and even in water tanks, while water quality beneath is greatly impacted by surficial ice formation. Floating weeds impair sunlight penetration and can disrupt the limnological balance in a water body causing excess formation of problematic contaminant compounds. In addition, other weeds and insects can have detrimental effects on water quality. The costs associated with treating and addressing the aforementioned water quality challenges can be extensive and only solve the problem(s) temporarily. These ponds and reservoirs employed for various purposes including water supply, recreational activities, and wastewater treatment, demand effective solutions to mitigate these adverse effects. Traditional methods can involve harmful chemicals, expensive mixers and aerators, expensive covers, and even physical/chemical treatment of the water with clarifiers or filters. However, these methods are costly and often reactive which do not address the underlying root causes. Therefore, it would be advantageous to have an environmentally friendly, inexpensive, comprehensive solution to address water quality problems.

### BRIEF SUMMARY OF THE INVENTION

The present invention are methods and an apparatus to create waves on the surface of a water body at select times, amplitude, frequency, water characteristics, or environmental conditions to affect sunlight penetration, heat and mass transfer, mixing, oxygenation, ice formation, weed suppression, and other factors.

Specifically, by creating waves on the surface of a water body, sunlight penetration is impacted by changing the angle of incidence of the incoming light. Reflecting sunlight off the surface when it otherwise would penetrate allows for manipulation and control of algal formation, heating and cooling of the water body, and other preferred outcomes. Waves also increase the surface area, so the creation of waves at select times and environmental conditions can allow for manipulation and control of reservoir heating, cooling, and oxygenation. Waves can reduce ice formation during freezing conditions, and waves can impair and damage floating weed populations. By allowing waves to be created and established at times other than those formed by the environment (wind), several beneficial outcomes can be achieved.

In a preferred embodiment, a mechanical wave generator is disclosed. The wave generator comprises of a floating buoy base that has sufficient weight to generate a specific wave amplitude and profile. Therefore, the buoy base displaces enough fluid to enable the mechanical wave generator to float in the fluid.

The preferred embodiment additionally comprises an oscillating central shaft, wherein the central shaft is located approximately in the center of the buoy supported by end support shaft bearings. The shaft bearings support the axial and radial loads generated by the oscillating central shaft and a counterweight. As used herein, the term oscillating includes rotating, reciprocating and any other movement that can create a specific wave amplitude and profile.

The embodiment further comprises a height adjustment mechanism that supports the counterweight. The height adjustment mechanism allows the counterweight to be adjusted vertically along the central shaft. Further, the counterweight is adjustable in or out with relation to the central shaft; wherein a combination of a height and a distance from the central shaft creates a rocking motion that generate waves in the fluid, and wherein the counterweight has a weight sufficient to move the mechanical wave generator in specific sized motions to create specified sized waves.

This embodiment also comprises an electric gearmotor which moves the central shaft. Preferably, the gearmotor has the ability to change speeds to change frequency and amplitude of the generated waves.

Another embodiment comprises of multiple anchor points on the floating base buoy to inhibit the mechanical wave generator from rotating in the fluid.

Preferably in these embodiments, the floating buoy base ranges from approximately 36 to 96 inches in diameter and the central shaft has a shaft height approximately ranging between 24 to 48 inches.

Additionally in most embodiments, the mechanical wave generator has a total weight that is approximately between 50 and 400 pounds and the total weight is selected to create the specified sized waves.

In these preferred embodiments, the amplitudes of the generated waves are approximately in the range of 1 to 12 inches from a lowest point to a highest point on each wave and the frequency of the generated waves is approximately between 0.1 and 10 HZ such that a wave will pass any given point in the body of fluid approximately every 10 seconds to 0.1 seconds.

Other embodiments comprise a power system where one or more mechanical wave generators can be powered by the power system or has a control system where the control system that has the ability based on battery reserve to either slow the motor down or not run in certain timeframes in order to conserve energy.

Another embodiment comprises a method of altering water conditions of a body of water by mechanically creating waves by an oscillating apparatus at select times, amplitude, or frequency.

In this embodiment the creating waves on a surface of the body of water impacts sunlight penetration by changing an angle of incidence of incoming light. The changing of an angle of incidence can reflect a greater amount of sunlight off the surface reducing heating of the body of water. Reflecting greater amount of sunlight affects algae growth by impairing photosynthesis. The waves can also agitate the surface of the body of water reducing ice formation on the surface. Conversely, the waves created at other select times can increase sunlight absorption resulting in warming the body of water.

In further embodiments, the waves impair growth and damage a floating or rooted weed population. Likewise, the waves generated create an environment where insect larva or other insect lifecycles are compromised from normal growth.

Furthermore, the waves can be generated to increase the surface area of the water body allowing for greater heat transfer to an atmosphere above the surface. Thus, the increase in surface area at select times and environmental conditions enable control of heating, cooling, and even oxygenation of a body of water.

Additional buoys may used to multiply the amplitude of the waves to cause more turbulent surface of the water for sun reflection or to increase a water surface area for heating and cooling of the body of water. This phenomenon is known as Wave Interference. Wave Interference is a phenomenon where waves generated from 2 devices can create constructive interference which greatly increases the intensity of the waves on the body of water. These wave interferences will cause high and low pressure between waves causing more turbulence, destruction of weeds, and better heat penetration from the sun. These waves when overlapped and the 2 waves are at a specific phases from one another will cause a wave displacement equal to the sum of the singular wave amplitude.

Other embodiments comprise a method of altering conditions of a fluid by mechanically creating waves by an oscillating apparatus at select times, amplitude, or frequency, wherein the waves generated are used to mix or aerate a fluid.

Yet other embodiment mechanically creates waves that cultivate a population of settleable microorganisms which remove contaminants when fluidized up into a water column and settle out when the oscillating apparatus is not operating.

In another embodiment, created waves are created with two oscillating apparatuses placed in the body of water to create wave interferences. The wave interferences will cause high and low pressure between waves causing more turbulence, increased destruction of weeds or insects, and better heat penetration from the sun.

### BRIEF DESCRIPTION OF THE DRAWINGS

Various embodiments are illustrated by way of examples in the figures of the accompanying drawings. Such embodiments are demonstrative and not intended to be exhaustive or exclusive embodiments of the present subject matter. The drawings are not necessarily to scale, emphasis instead being placed on illustrating the principals of the invention.

FIG. 1 is an isometric view of a mechanical wave generator in a preferred embodiment.

FIG. 2 depicts a side view of a mechanical wave generator in a preferred embodiment.

FIG. 3 depicts a mechanical wave generator anchoring system in a preferred embodiment.

FIG. 4A depicts sunlight interaction with a water surface without waves.

FIG. 4B depicts sunlight interaction with waves on a water surface.

FIG. 5A depicts a frozen pond surface without mechanical wave generation.

FIG. 5B depicts a partial frozen pond surface with mechanical wave generation.

FIG. 6A depicts water weeds without mechanical wave generation.

FIG. 6B depicts water weeds with mechanical wave generation.

FIG. 7 depicts a water turbulence in pond with mechanical wave generation.

FIG. 8 depicts created waves that are created with two oscillating apparatuses placed in the body of water to create wave interferences.

### DETAILED DESCRIPTION OF THE INVENTION

The description that follows includes compositions, systems, methods, and apparatuses that embody various elements of the present disclosure. However, it should be understood that the described disclosure may be practiced in a variety of forms in addition to those described herein. Accordingly, the referenced drawings show, by way of illustration, specific embodiments in which the invention may be practiced. It is to be understood that other embodiments may be utilized, and structural changes may be made without departing from the scope of the claims. It is further understood that the steps described with respect to the disclosed processes may be performed in differing order and are not limited to the steps presented herein. Accordingly, other implementations describing object sizing, processes, elements, parts or mechanisms can be used and still be within the scope of the claimed invention.

In the preferred embodiments described herein, a mechanical wave generator is disclosed with the various effects it produces on water quality or on other fluids. The mechanical wave generator creates waves on the surface of a body of fluid at select times, amplitude, frequency, water characteristics, or environmental conditions to affect sunlight penetration, heat and mass transfer, mixing, oxygenation, ice formation, weed or insect suppression, and other factors that can affect its quality.

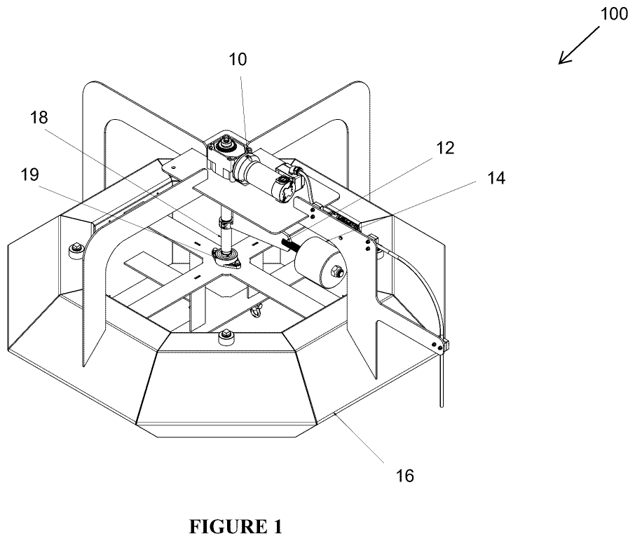

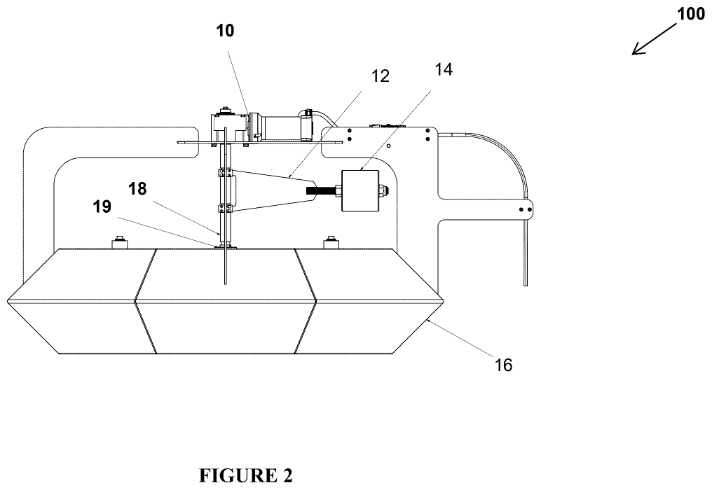

Referring to FIG. 1 and FIG. 2, illustrated are an isometric view and a side view respectively of a mechanical wave generator 100 in the preferred embodiment. The mechanical wave generator 100 typically ranges from 36 inches to 96 inches in diameter and 24 inches to 48 high as required for the size of the body of fluid being treated. The weight of the machine typically is between 50 lbs to 200 lbs. Weight is adjusted to create larger or smaller wave amplitudes.

In this preferred embodiment, a floating buoy base 16 generates a specific wave amplitude and profile. The base 16 supports all moving mechanisms. Naturally, the base 16 displaces sufficient fluid to allow the unit to float in the fluid.

This embodiment additionally comprises an oscillating central shaft 18 located approximately in the center of the buoy 100 supported by end support shaft bearings 19. The shaft bearings 19 support the axial and radial loads generated by the oscillating central shaft 18 and a counterweight 14. As used herein, the term oscillating includes rotating, reciprocating and any other movement that can create a specific wave amplitude and profile.

A support mechanism 12 upholds the counterweight 14. A specific sized counterweight creates the rocking motion of the system. The counterweight 14 is heavy enough to move the mechanism in specific sized motions thus creating specific sized waves. The support mechanism 12 allows the counterweight 14 to be adjusted vertically along the shaft 18 as well as adjusting the counterweight 14 in/out with relation to the center axes thus adjusting the behavior of the base 16 in its rocking motion to generate the specific waves.

An electric gearmotor 10 turns the central shaft 18. The gearmotor 10 should have the ability to change speed and thus change the frequency and amplitude of the generated waves. A control system can have the ability based on battery reserve to either slow the motor 10 down or not run in certain timeframes in order to conserve energy.

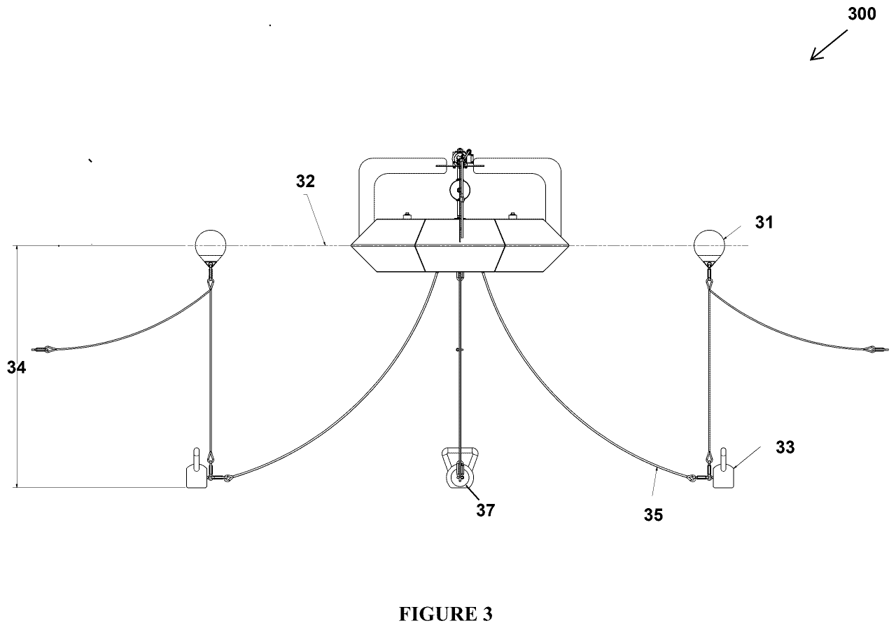

Referring to FIG. 3, illustrated is an side view of the mechanical wave generator anchor system 300 in a preferred embodiment. The mechanical wave generator is towed to its location via an anchor and tow assembly 37. As shown, other anchor weights 33 help anchor the mechanical wave generator 100 to a fixed location. The anchor cables 35 attach to the wave generator 100 and secure the anchor weights 33. Anchor locating buoys 31 float on the water surface 32 corresponding to the location of the anchor weight at the reservoir bottom at the water depth 34.

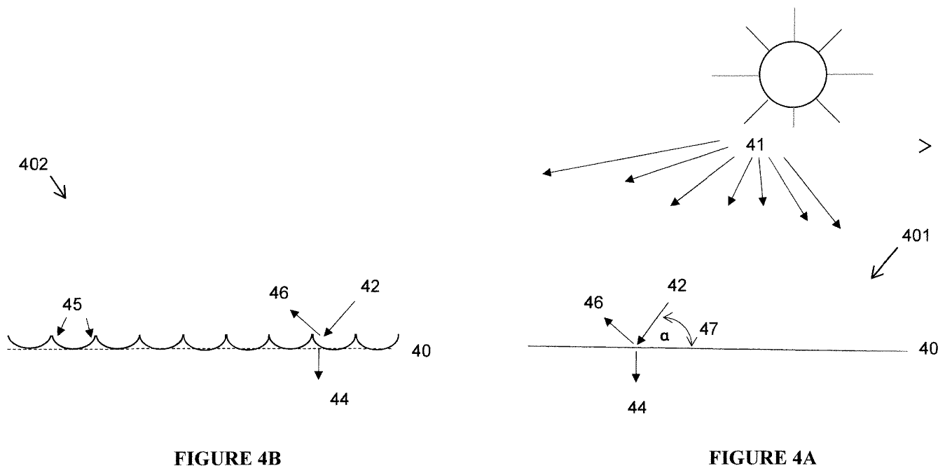

Referring to FIG. 4A, depicted is sunlight 41 interaction with a water surface without waves 401. On a water surface 40 without waves 401, sunlight 41 interacts in a relatively straightforward manner. As light 41 hits the smooth water surface 40, a portion of the light is reflected 46. As the angle 47 between the incoming light 42 and the water surface 40 increases (becomes more oblique), the amount of reflected light 46 increases. At very shallow angles (close to parallel with the water), nearly all light 41 is reflected 46, creating the mirror-like effect we see on calm water surfaces. The rest of the light 44 penetrates the water, where it may be absorbed or scattered by particles in the water, giving the water its characteristic color. The angle 47 at which light 42 enters the water affects how much is reflected versus how much penetrates, with more light 41 being reflected 46 at shallower angles 47.

Referring to FIG. 4B, depicted is sunlight 41 interactions on a water surface with waves 402. When waves 45 are present on the water surface 40, the interaction becomes more complex and dynamic. As sunlight 41 strikes the water, some of it is reflected 46 off the surface 40 while some sunlight penetrates 44 and is refracted within the water. By creating waves 45 on the surface 40 of a water body, sunlight penetration 44 is impacted by changing the angle 47 of incidence of the incoming light 42. The amount of sunlight reflected 46 from water waves 45 varies based on wave size. Ripples create a variety of surface angles, increasing the chances that some portion of the surface 40 will be at an optimal angle 47 for reflection 46, regardless of the sun's position. Reflecting sunlight 46 off the surface 40 when it otherwise would penetrate 44 allows for manipulation and control of algal formation, heating and cooling of the water body, and other preferred outcomes.

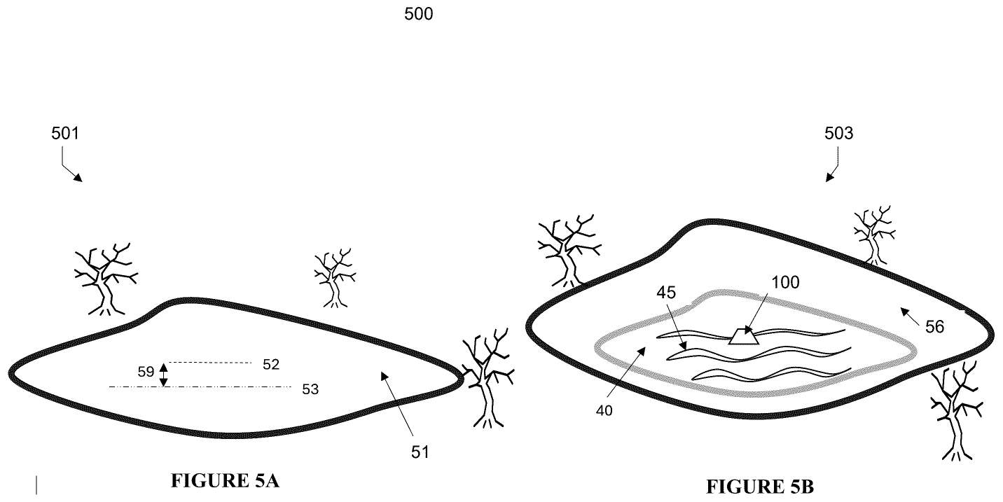

FIG. 5A depicts a frozen pond surface without mechanical wave generation 501. In most bodies of water during the hot summers, a top layer 52 consists of lower density warm water that exists above the water layer below 53 consisting of denser colder water. As air temperatures drop in the fall months, this warm layer 52 begins to cool. After it has cooled, it reaches the same density as the water below 53. The water column 59 will be relatively isothermal. Upon further cooling, the water near the surface 52 becomes even denser and descends mixing with the water below 53. Thus, the lake continues to remain isothermal but at colder temperatures. This process continues until the water temperature drops to that of the maximum density of water (about 4° C. or 39° F.). Further cooling then results in expansion of the space between water molecules, such that the water becomes less dense. This change in density tends to create a new stratified thermal structure, this time with the lighter colder water 52 on top of the denser warmer water 53. If there is no mixing of the water by wind or other mechanical means, this top layer 52 will cool to the freezing point (0° C. or 32° F.). Once it is at the freezing point, further cooling will result in ice formation at the surface 40. This layer of ice 51 will effectively block an exchange of energy between the cold air above and the warm water below 52. Therefore, any more cooling continues only at the surface 40, which results in the production of ice.

Turning now to FIG. 5B, depicted is a partial frozen pond surface with waves 503 by a mechanical wave generator 100. Waves 45 play a crucial role in preventing the formation of ice 56 on lakes by constantly agitating the water surface 40. The movement of waves 45 disrupts the calm and still conditions that are typically required for ice to form. When the surface water 40 remains in motion, it becomes more difficult for the water to cool uniformly to the freezing point, as the mixing of warmer and cooler water layers hinders the formation of ice 56. Additionally, waves 45 continually agitate this surface 40, breaking up any initial ice crystals that form by mixing the colder surface water with slightly warmer water below.

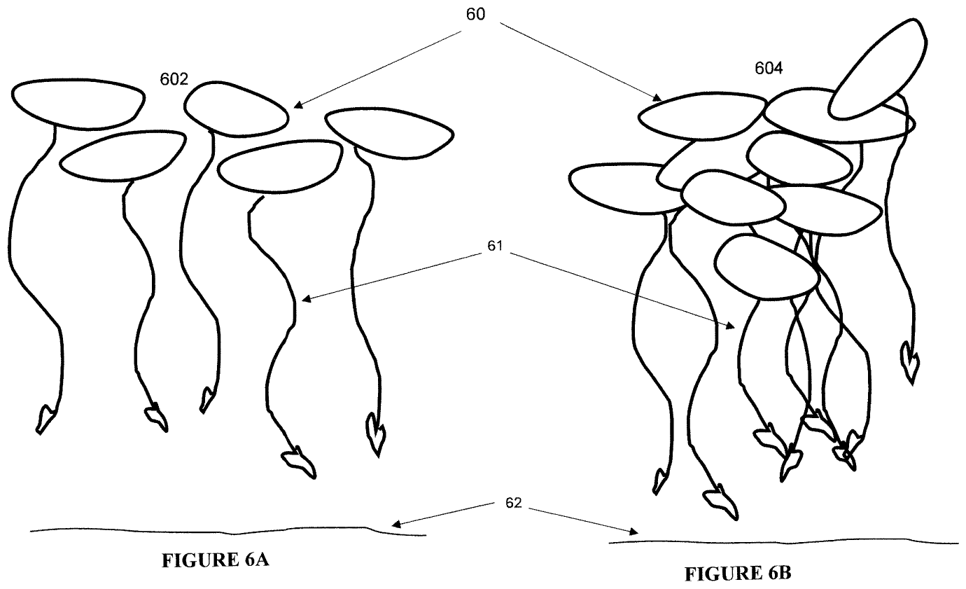

FIG. 6A depicts water weeds in a body of water without mechanical wave generation 602. Calm water 401 is particularly beneficial for floating plants 60 like water lilies, duckweed, and water hyacinths. In still water 401, these plants 60 can easily stay on the surface without being pushed or submerged by waves 45 or currents. The lack of water movement allows them to spread out and cover large surface areas, maximizing their exposure to sunlight, which is crucial for photosynthesis. Since floating plants 60 do not have deep root systems 61 and often rely on nutrient absorption from the water itself, calm conditions 401 prevent the washing away of essential nutrients, ensuring they remain available for the plants.

Likewise, calm waters 401 allow plants 60 to anchor more easily in the sediment 62. In still waters 401, the delicate root systems 61 of plants like lilies, cattails, and pondweeds can establish themselves without the risk of being uprooted. The absence of turbulent water also minimizes sediment disturbance, which can otherwise cloud the water and limit the light 44 available for photosynthesis. With consistent light penetration 44 and stable conditions, water plants 60 can grow more vigorously, absorbing nutrients from both the water column 59 and the sediment below.

FIG. 6B depicts water weeds in a body of water with mechanical wave generation 604. Waves 45 can significantly damage water plants 60 and hinder their growth by creating physical stress and disturbance in their environment. The constant motion caused by waves 45 can uproot aquatic plants 60, especially those with shallow or delicate root systems 61. Plants 60 that grow in soft sediment 62 or have not yet fully established their roots are particularly vulnerable to being displaced by strong wave action. Even if the plants 60 are not entirely uprooted, the shifting of sediment 62 caused by waves 45 can expose their roots 61, making it difficult for them to anchor securely, and reducing their access to essential nutrients in the substrate.

In addition to root 61 damage, waves 45 can also break or tear the stems and leaves of water plants 60, particularly for species that grow partially or fully submerged. The mechanical force of moving water can bend or snap plant structures, making it harder for the plants to carry out photosynthesis and nutrient uptake. Additionally, waves 45 stir up sediment 62 in the water, making it murky and reducing light penetration 44. This limits the amount of sunlight 41 that reaches submerged or floating plants 60, which rely on consistent light for photosynthesis. As a result, both the physical damage and the disruption to nutrient and light availability caused by waves 45 can severely limit water plant growth.

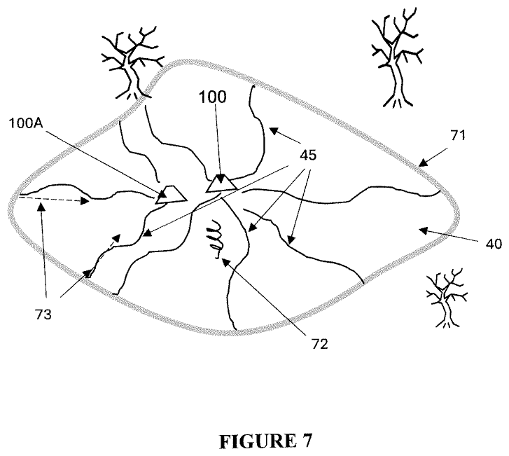

FIG. 7 depicts a water turbulence in pond with mechanical wave generation 700. These mechanically created waves 45 can be used to mix or aerate a fluid. The waves 45 increase a surface area such that the waves 45 created at select times and environmental conditions enable control of heating, cooling, or oxygenation of a body of water 700. The increased surface area of the fluid allows for greater heat transfer to the atmosphere above the surface 40. Similarly, the turbulence created by waves 45 increases the rate of oxygen absorption from the atmosphere into the water 700. This process helps circulate nutrients and oxygen throughout the water column 59. Likewise, agitation helps release excess carbon dioxide from the water 700 into the air helping to maintain a balanced pH level. As waves 45 move across a lake surface 40, they create turbulence that mixes the upper layers of water. Larger waves can cause vertical mixing, bringing deeper water to the surface 40 and vice versa. Furthermore, waves 45 can generate a series of shallow vortices 72 that further enhance mixing and aeration. This mixing helps distribute heat, nutrients, and dissolved gases more evenly.

As waves 45 approach a shore 71, they break due to decreasing water depth. This breaking action creates turbulence, mixing water vertically and horizontally. After the wave 45 breaks, surface water 40 rushes up the shore 71. The water 40 then returns back into the lake 700. As waves 45 break and water piles up near the shore 71, some of it returns to the lake 700 along the bottom, creating an undertow 73. This back-and-forth motion mixes sediments in the water near the shore. Additionally, when waves 45 break, they create tiny air bubbles that get mixed into the water 700. These bubbles increase the surface area between air and water, facilitating gas exchange.

Waves 75 in a lake 700 have significant impacts on insect growth and life cycles, often creating challenging conditions for certain species. Waves 45 generated can create an environment where insect larva or other insect lifecycles are compromised from normal growth. Many aquatic insects lay eggs on calm water surfaces 41 or aquatic vegetation. Wave 45 action can dislodge eggs or prevent successful attachment. In addition, constant wave 45 motion can physically damage delicate insect larvae or nymphs. Furthermore, waves 45 can erode shorelines 71 and disturb aquatic vegetation 60. This disrupts habitats crucial for many insect species during various life stages. Some aquatic insects are filter feeders or rely on still water 41 to detect prey. Wave 45 action can make it difficult for these insects to feed efficiently. Strong wave action can wash away or disperse insect larvae to unfavorable areas of the lake 700. Wave 45 induced sediment suspension can increase water turbidity. This may interfere with visual predators or reduce light penetration 44 for photosynthesis, indirectly affecting insect food sources.

Created waves 45 can cultivate a population of settleable microorganisms that remove contaminants when fluidized up into a water column 59 and settle out when the oscillating apparatus is not operating. Mechanical wave generator 50 can promote the growth of water treating microorganisms and algae while also deterring toxic type bacteria. This formation of dominant, beneficial, settleable microorganisms, such as Chlorophyta and Heterokontophyte, combined with its suppression of non-beneficial microorganisms, such as Cyanobacteria, allows for purification of both soluble and insoluble contaminants in the water. After the apparatus 50 is turned off, these beneficial microorganisms may traverse through the water column 59 to sweep out contaminants down the water column 59 treating the water 700. The frequency of intermittent operation, fluidization and settling, can be tailored to address various treatment applications, such as algae removal, total suspended solids reduction, turbidity reduction, Ammonia and/or Phosphorus removal, effect biochemical oxygen demand and many others

Additional mechanical wave generation buoys 100A used to multiply the amplitude of the waves 45 to cause more turbulent surface 40 of the water for sun reflection or to increase a water surface area for heating and cooling of the body of water. One or more mechanical wave generators 100, 100A can be powered by a power system.

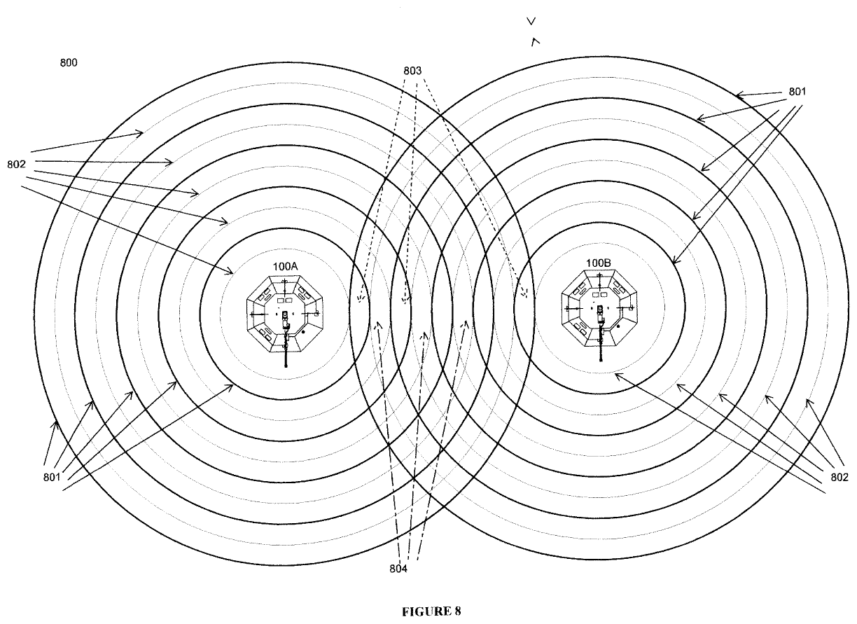

FIG. 8 depicts created waves with 2 mechanical wave generating units (100A, 100B) placed in the body of water that create wave interference 800. Wave interference is a phenomenon that occurs when waves generated from two sources interact which leads to patterns of constructive and destructive interference. In constructive interference, the waves align in phase, causing their amplitudes to add together, which significantly increases the intensity of the resulting wave. This effect is particularly impactful on bodies of water, where overlapping waves can create regions of high 803 and low pressure 804. The high-pressure zones 803, where two waves of similar amplitudes intersect, amplify the wave's energy, while low-pressure zones 804, where waves of differing amplitudes overlap, lead to partial or complete cancellation of wave energy.

The interplay of high 803 and low-pressure zones 804 in wave interference has notable environmental and practical effects. High-pressure zones 803 amplify energy, fostering greater turbulence and promoting mixing in the water, which can aid in heat distribution from sunlight to deeper layers. On the other hand, the low-pressure zones 804 diminish wave energy. The interaction between thick (high amplitude) 801 and thin (low amplitude) 802 waveforms illustrates this balance, with high-pressure zones 803 being additive and low-pressure zones 804 resulting in cancellation. This phenomenon not only influences the physical characteristics of the water but also has potential applications in controlling aquatic ecosystems, such as managing weed or insect growth through mechanical disruption.

1. A mechanical wave generator comprising:
a floating buoy base of sufficient weight to generate a specific wave amplitude and profile, wherein the buoy base displaces enough fluid to enable the mechanical wave generator to float in the fluid;
an oscillating central shaft, wherein the central shaft is located approximately in the center of the buoy supported by end support shaft bearings, wherein the shaft bearings support axial and radial loads generated by the oscillating central shaft and a counterweight;
a height adjustment mechanism that supports the counterweight, wherein the height adjustment mechanism allows the counterweight to be adjusted vertically along the central shaft;
the counterweight is adjustable in or out with relation to the central shaft; wherein a combination of a height and a distance from the central shaft creates a rocking motion that generate waves in the fluid, and wherein the counterweight has a weight sufficient to move the mechanical wave generator in specific sized motions to create specified sized waves;
an electric gearmotor which moves the central shaft, wherein the gearmotor has the ability to change speeds to change frequency and amplitude of the generated waves

2. The mechanism of claim 1, further comprising multiple anchor points on the floating base buoy to inhibit the mechanical wave generator from rotating in the fluid.

3. The mechanism of claim 1, wherein the floating buoy base ranges from approximately 36 to 96 inches in diameter.

4. The mechanism of claim 1, wherein the central shaft has a shaft height approximately ranging between 24 to 48 inches.

5. The mechanism of claim 1, wherein a total weight of the mechanical wave generator is approximately between 50 and 400 pounds.

6. The mechanism of claim 5, wherein the total weight is selected to create the specified sized waves.

7. The mechanism of claim 1, wherein the amplitude of the generated waves is approximately in the range of 1 to 12 inches from a lowest point to a highest point on each wave.

8. The mechanism of claim 1, wherein the frequency of the generated waves is approximately between 0.1 and 10 HZ such that a wave will pass any given point in the body of fluid approximately every 10 seconds to 0.1 seconds.

9. The mechanism of claim 1, further comprising a power system, wherein one or more mechanical wave generators can be powered by the power system.

10. The mechanism of claim 1, further comprising a control system, wherein the control system has the ability based on battery reserve to either slow the motor down or not run in certain timeframes in order to conserve energy.

11. A method of altering water conditions of a body of water by mechanically creating waves by an oscillating apparatus at select times, amplitude, or frequency.

12. The method of claim 11, wherein the creating waves on a surface of the body of water impacts sunlight penetration by changing an angle of incidence of incoming light.

13. The method of claim 12, wherein by the changing of an angle of incidence reflects a greater amount of sunlight off the surface reducing heating of the body of water.

14. The method of claim 13, wherein reflecting the greater amount of sunlight affects algae growth by impairing photosynthesis.

15. The method of claim 11, wherein the waves agitate a surface of the body of water reducing ice formation on the surface.

16. The method of claim 12, wherein the waves created at select times increase sunlight absorption resulting in warming the body of water.

17. The method of claim 11, wherein the waves impair growth and damage a floating or rooted weed population.

18. The method of claim 11, wherein the waves increase a surface area such that the waves created at select times and environmental conditions enable control of heating, cooling, or oxygenation of a body of water.

19. The method of claim 18, wherein the waves are generated to increase the surface area of the water body allowing for greater heat transfer to an atmosphere above the surface.

20. The method of claim 1, further comprising of additional buoys used to multiply the amplitude of the waves to cause more turbulent surface of the water for sun reflection or to increase a water surface area for heating and cooling of the body of water.

21. The method of claim 11, wherein the waves generated create an environment where insect larva or other insect lifecycles are compromised from normal growth.

22. The method of claim 11, wherein the created waves are created with two oscillating apparatuses placed in the body of water to create wave interferences, wherein the wave interferences will cause high and low pressure between waves causing more turbulence, increased destruction of weeds or insects, and better heat penetration from the sun.

23. A method of altering conditions of a fluid by mechanically creating waves by an oscillating apparatus at select times, amplitude, or frequency, wherein the waves generated are used to mix or aerate a fluid.

24. The method of claim 22, wherein the created waves cultivate a population of settleable microorganisms that remove contaminants when fluidized up into a water column and settle out when the oscillating apparatus is not operating.
